(19) United States
(12) Patent Application Publication
(10) Pub. No.: US 2016/0180514 A1
(43) Pub. Date: Jun. 23, 2016

(54) IMAGE PROCESSING METHOD AND ELECTRONIC DEVICE THEREOF

(71) Applicants: LITE-ON ELECTRONICS (GUANGZHOU) LIMITED, Guangzhou (CN); LITE-ON TECHNOLOGY CORPORATION, Taipei City (TW)

(72) Inventor: CHING-FENG CHENG, TAIPEI CITY (TW)

(21) Appl. No.: 14/852,716

(22) Filed: Sep. 14, 2015

(30) Foreign Application Priority Data
Dec. 17, 2014 (CN) 201410789758.8

(51) Int. Cl. G06T 7/00; G06T 11/60

(52) U.S. Cl. CPC G06T 7/004; G06T 7/0081; G06T 11/60

(57) ABSTRACT

An image processing method and an electronic device thereof are provided. In the method, depth values of a plurality of objects in an original image can be determined according to a depth map that corresponds to the original image. The objects include at least one first object and at least one second object, and the depth value of the first object is less than that of the second object. Then a reference depth value is obtained. The at least one first object and a background image are obtained from the original image. The size of the first object may remain intact or be magnified. The depth value of the at least one first object is less than or equal to the reference depth value. A frame image is generated. The at least one first object and the background image overlap respectively in front of and behind the frame image.

### BACKGROUND OF THE INVENTION

1. Field of the Invention

The present disclosure is related to an image processing method and an electronic apparatus therefor, in particular, to the method and apparatus able to highlight a target image in front of a frame image for rendering an image with a stereoscopic visual effect.

2. Description of Related Art

In the real world, two offset images are required to be simultaneously projected to the human eyes in order to render a 3D image in a human's brain. In general, when the two images are separately entered to the left and right eyes in parallel, a visual parallax is formed because the eyes overlap the images. The parallax generates the stereoscopic effect for a human. For example, a 3D display splits entering image signals through an optical grating and allows the human eyes to receive the offset images. The offset images are projected onto the eyes along a horizontal direction so as to form the parallax. Alternatively, the person may wear special glasses, e.g. the red/blue (green) anaglyph glasses, to receive different colors images for generating the parallax. Thus, the human brain will automatically recombine the offset images and create the stereoscopic imaging effect because of the parallax.

However, the conventional technology always requires specific hardware to embody the stereoscopic effect.

### SUMMARY OF THE INVENTION

The disclosure in accordance with the invention is related to an image processing method and an electronic apparatus implementing the method. In the method, the relative depth relationship among multiple objects in an image may be determined according to a depth map. A selected target object may be magnified and overlapped in front of a frame image in order to make the target object to be conspicuous through a stereoscopic effect.

In an embodiment of the method, a depth map of an original image is provided to determine depth values of a plurality of objects in the original image. The objects include at least one first object and at least one second object. The depth value of the first object is defined to be smaller than the depth value of the second object. A reference depth value is then defined. The at least one first object and a background image are extracted from the original image. In one aspect of the embodiment, the at least one first object is kept at the original size of the image. In another aspect, the at least one first object is magnified. It is also configured that the depth value of the at least one first object is smaller than or equal to the reference depth value; and the depth value of the at least one second object is larger than the reference depth value. A frame image is then created, and the at least one first object and the background image are respectively overlapped in front of or in the rear of the frame image. The overlapped at least one first object(s), the frame image and the background image are then combined as a composite image.

In one further embodiment, an electronic apparatus is provided. The electronic apparatus includes a display module and a processing module. The processing module is coupled to the display module. The processing module is used to perform the image processing method so as to render a composite image in which the at least one first object can be conspicuous in front of a frame image. The display module is used to display the original image and the composite image.

In summation, in the image processing method and the electronic apparatus in accordance with the invention, a depth map is introduced to determining the relative relationship in depth among the objects in an image. A target object and a background image are selected from an original image. The target object may be magnified and overlapped in front of a frame image, and the background image may be overlapped in back of the frame image for rendering the target image conspicuous with stereoscopic effect. In other words, the method achieves a low cost solution to create a stereoscopic image as compared to the conventional arts because the electronic apparatus in the method merely requires an original image and a corresponding depth map to render the visual stereoscopic effect in the picture.

### BRIEF DESCRIPTION OF THE DRAWINGS

FIG. 1 shows a block diagram to describe the electronic apparatus according to one embodiment in the disclosure;

FIG. 2 schematically shows a full depth map in one embodiment in the disclosure;

FIG. 3 schematically shows a first composite image in one embodiment in the disclosure;

FIG. 4 schematically shows a second composite image in another embodiment in the disclosure;

FIG. 5 schematically shows a third composite image in one further embodiment in the disclosure;

FIG. 6 shows a schematic diagram describing a full depth map according to another embodiment in the disclosure;

FIG. 7 schematically shows a fourth composite image in one embodiment in the disclosure;

FIG. 8 shows a flow chart illustrating the image processing method according to one embodiment in the disclosure;

FIG. 9 shows a flow chart illustrating the method in another embodiment in the disclosure.

### DETAILED DESCRIPTION OF THE PREFERRED EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or referenced herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

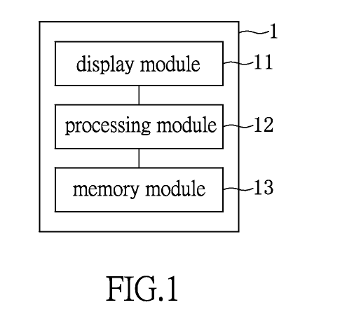

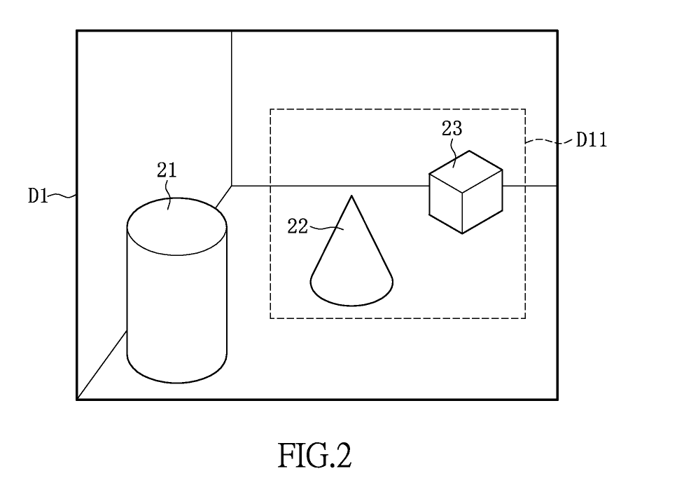

References are made to both FIG. 1 and FIG. 2. FIG. 1 shows a block diagram to describe an electronic apparatus according to one embodiment of the present invention. FIG. 2 schematically shows a full depth map according to the embodiment of the present invention.

As shown in FIG. 1, an electronic apparatus 1 includes a display module 11, a processing module 12, and a memory module 13. The processing module 12 is coupled with both the display module 11 and the memory module 13. In the present embodiment, the electronic apparatus 1 may be a mobile phone, a notebook computer, a desktop computer, a tablet, a digital camera, a digital photo album, or any electronic apparatus with capabilities of digital computation and display. However, the electronic apparatus 1 should not be limited to any particular kind of electronic device.

The memory module 13 is a storage medium which is selected from a buffer memory, a tangible memory, and an external storage. The external storage may be such as an external memory card. The memory module 13 stores a captured picture and a corresponding depth map created by an image processing procedure. For example, a full depth map D1 shown in FIG. 2 represents a picture whose foreground and background images are clear. A depth map with respect to the picture is also created. The scenes involved in the full depth map D1 can be represented by objects 21, 22, and 23. The object 21 is represented by a cylinder; the object 22 is represented by a conoid, and the object 23 is represented by a cube. In the current example, the object 21 has smallest depth value compared to the object 22 and object 23, and the object 23 has the deepest depth value.

When the depth values of the objects 21, 22, and 23 are represented by a depth map, the object 21 has minimum grayscale, and the object 23 has maximum grayscale relatively. In an example using 256 levels of grayscale, the values of the grayscale are indicated by 0 through 255, in which the numeral 0 indicates the most white, and the numeral 255 is for most black. It is worth noting that the method may not be limited to the images stored in the memory module 13. That means the full depth map D1 may also be applied to other captured scenes, or even a partial clear image. The depth map with respect to the full depth map D1 can be created by the methods of Laser ranging, binocular vision, structured lighting, or light field. However, the creation of the depth map will not be described in detail here since it is conventional technology well-known by those skilled in the art. The depth map may be depicted by grayscale levels. The pixel with darker color means the grayscale value of the pixel is higher. However, the embodiment in the disclosure may not be limited to this example, but also can use the darker pixel to represent the pixel with lower grayscale value, in which the value “0” may indicate the darkest pixel, and the value “255” may otherwise indicate the whitest pixel. As long as the depth map is configured to convey the distance information.

The processing module 12 may retrieve the full depth map D1 and the corresponding depth map from the memory module 13. The depth map allows determining the distance relationship among the objects 21, 22, and 23, and rendering the depth values with respect to the objects 21, 22, and 23. Further, the processing module 12 may extract the object 21, object 22, and the object 23 separately from the full depth map D1 according to the depth map. Since the method to retrieve information of the objects from the depth map is disclosed in the conventional technology, it will not be detailed herein .

Furthermore, the processing module 12 is used to decide a target object overlapped in front of a reference plane based on the reference depth value and the depth value with respect to every object. A background image is then overlapped behind the reference plane. The mentioned reference plane is such as a frame image. Next, the processing module 12 combines the overlapped target object, the frame image, and the background image so as to create a composite image. The background image is generated by the processing module 12 based on the full depth map D1. The background image may include the target object and the object with the depth value larger than the depth value of the target object. In an exemplary example, the processing module 12 may be in a form of integrated circuit (IC), or a firmware associated with a micro-controller. The processing module 12 may also be, but is not limited to, a software module executed by a CPU.

According to one embodiment of the present invention, according to the depth map, the processing module 12 is further used to determine a range for the respective depth value with respect to the object 21, object 22, or object 23. The processing module 12 may exemplarily regard the minimum depth value for the object 21, the object 22, or the object 23 as the depth value for every object. For example, the processing module 12 may regard the object 21 with depth value “20” when the range of the depth value for the object 21 is 20 to 100.

Further, the memory module 13 may store another full depth map. The object in this full depth map may merely have one depth value, not a range of the depth values. The processing module 12 then regards the single value as the depth value for the object.

The display module 11 is able to display the full depth map D1. The processing module 12 receives the composite image, and then the display module 11 displays the composite image. According to the one of the embodiment, the display module 11 is such as, but is not limited to, a liquid-crystal display, or a touch-sensitive display. A skilled person in the field of the invention can modify the form of display module 11 according to demands.

In the present embodiment, the display module 11 displays the stored full depth map, which is not limited to the full depth map shown in FIG. 2, to be provided for the user to select one object. The processing module 12 decides a reference depth value according to the depth value of the selected object. That is, the processing module 12 decides the reference depth based on the depth value of the selected position. Alternatively, in one further embodiment, the display module 11 may configure an icon indicator, shown in the stored full depth map, to be provided for the user to select a reference depth value. The icon indicator may indicate a range of the depth value. The depth value is within the range of grayscale values “0” to “255” which may be adjusted by a scroll bar. The larger grayscale value means the larger depth value indicating a deeper depth of field. The embodiment in the disclosure may not be limited to the present example.

When the processing module 12 retrieves the reference depth value, the relationship between the reference depth value and the depth values for multiple objects can be determined. After that, the object with the depth value smaller than or equal to the reference depth value can be made conspicuous by magnifying this object in front of the frame image. Therefore, a stereoscope effect can be achieved.

In one further embodiment in the disclosure, if the processing module 12 finds there are multiple objects with the depth values smaller than or equal to the reference depth value when the processing module 12 receives a reference depth value, the processing module 12 selects one of the objects whose depth value is the highest the. The selected object acts as the target object. The target object overlaps the frame image. However, the embodiment in the disclosure does not limit the possible ways to decide the target object made by the electronic apparatus 1.

It is noted that, in the present embodiment, the user may manually input the full depth map D1 and the corresponding depth map to the memory module 13 of the electronic apparatus 1 when the electronic apparatus 1 has no camera module. For example, a desktop computer and digital photo album are electronic apparatus without camera modules. On the other hand, the smart phone or the digital camera is the electronic apparatus 1 with camera modules. The electronic apparatus 1 captures a plurality of images from a scene through its camera module. Next, the processing module 12 creates a depth map and a full depth map based on the plurality of images. The depth map and the depth of field map are also stored in the memory module 13. The camera module is coupled to the processing module 12. The camera module may be a single-lens camera module or a multi-lens camera module.

The following is for describing the embodiments of the image processing method and the operation of the electronic apparatus.

### First Embodiment

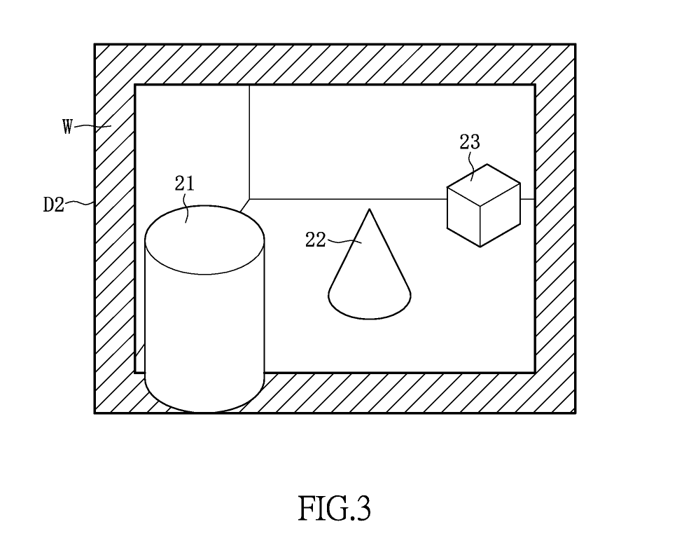

References are now made to FIGS. 1 to 3. FIG. 3 schematically shows a first composite image in one embodiment. When the user selects the object 21, acting as a target object, the processing module 12 extracts the object 21 from the full depth map D1 based on the depth map of the full depth map D1. The object 21 is then magnified. The processing module 12 regards the full depth map D1 as a background image. After that, a frame image W and the magnified object 21 overlap the background image in an order so as to form a composite image D2 as shown in FIG. 3. The object 21 is therefore standing out of the composite image D2. The picture with a stereoscopic effect is achieved.

### Second Embodiment

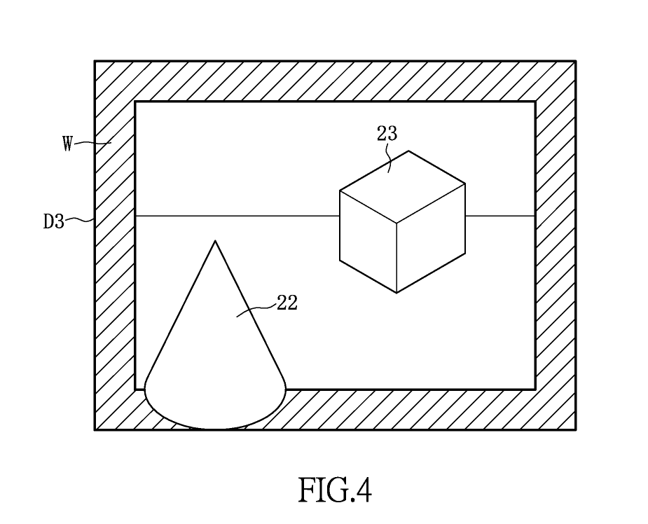

References are now made to FIGS. 1, 2, and 4. FIG. 4 schematically shows a second composite image according to one embodiment. When the user selects the object 22, acting as the target object, the processing module 12 extracts the object 22 from the full depth map D1 based on the depth map. Furthermore, the processing module 12 may extract some parts of the object 22 and the object 23 from the full depth map D1. In an exemplary example, the processing module 12 extracts the image D11, as shown in FIG. 2, from the full depth map D1. Next, the object 22 is magnified by the process made in the processing module 12. The image D11 also acts as the background image. Then the frame image W, the magnified object 22, and the background image are in order overlapped so as to form the composite image D3 shown in FIG. 4. The object 22 is therefore standing out of the picture, forming a stereoscopic image.

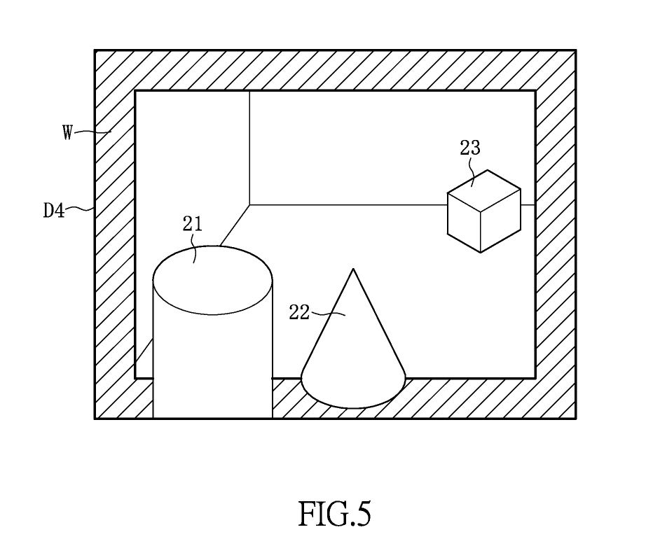

Reference is made to FIG. 5. FIG. 5 schematically shows a third composite image in one embodiment. It is different from the above embodiments since the processing module 12 extracts the object 21 with the depth value smaller than the reference depth value as well as extracting the object 22. This reference depth value is decided based on the depth value of the object 22 in the current example. According to the current embodiment, the object 21 and the object 22 are selected to be the target objects. The object 21 and the object 22 are magnified by the processing module 12. The full depth map D1 is the background image. With the background image, the frame image W and the magnified object 21 and object 22 are overlapped in an order. Then the composite image D4 shown in FIG. 5 is formed. The object 21 and the object 22 are conspicuous in front of the frame image W. It makes the picture have a stereoscopic effect. The processing module 12 may change the positions of the object 21 and the object 22 in the composite image D4 based on the distances of the object 21 and object 22. The distance relationship can be obtained based on the depth values of these two objects. Further, the magnifying power of the object 21 may be higher than the object 22. It is noted that the object has higher magnifying power when it has smaller depth value.

### Third embodiment

According to the current embodiment, an icon indicator shown in the display module 11 is provided for the user to select a reference depth value. References are made to FIGS. 1-3. The depth values 20, 100, and 200 are respectively designated to the object 21, object 22, and object 23. In an exemplary example, if the reference depth value is selected to be the value 50, the processing module 12 performs comparison between the reference depth value and the depth value of each of the object 21, object 22, and object 23 and the depth value of the object 21 is determined to be the target object since its depth value is smaller than reference depth value. The comparison performed by the processing module 12 shows the depth value of the object 21 is smaller than the reference depth value based on the information in the depth map. Therefore the object 21 in accordance with the present example acts as the target object. The object 21 is also magnified. Next, the processing module 12 regards the full depth map D1 as the background image. With the background image, the frame image W and the magnified object 21 are overlapped in order. Therefore, the composite image D2 shown in FIG. 3 is with a stereoscopic effect.

### Fourth Embodiment

References are made to FIGS. 1, 2, and 4. In an exemplary example, the depth values 20, 100, and 200 are respectively designated to the object 21, object 22, and object 23. If the user selects a reference depth value 150 through the graphic icon indicator, the processing module 12 then performs comparison between the reference depth value and the depth value for each of the object 21, object 22, and object 23. The object 21 and object 22 are found to have the depth values smaller than the reference depth value. The processing module 12 extracts the object 22 with the depth value which is smaller than the reference depth value and higher than the depth value of the object 21 based on the depth map of the full depth map D1. The object 22 is therefore regarded as the target object. An image D11 is retrieved from the full depth map D1. The processing module 12 then magnifies the object 22 and makes the image D11 to be the background image. The background image, the frame image W, and the magnified object 22 are in order overlapped. The composite image D3 with 3D visual effect shown in FIG. 4 is created.

Referring to the embodiment shown in FIG. 5, it is different from the above embodiments since the processing module 12 extracts the object 21 and object 22 with the depth values smaller than the reference depth value. Therefore, both the object 21 and the object 22 are regarded as the target objects. The processing module 12 accordingly magnifies the object 21 and the object 22. The full depth map D1 acts as the background image. The background image, the frame image W and the magnified object 21 and object 22 are overlapped in order so as to form the composite image D4 shown in FIG. 5. Both the object 21 and the object 22 are conspicuous for reaching the stereoscopic effect. It is noted that the processing module 12 is able to change the positions of the object 21 and the object 22 in the composite image D4 based on the depth values of objects. Further, the magnifying power for the object 21 is higher than the magnifying power of the object 22. That means when the depth value of the object is smaller, the magnifying power is higher.

### Fifth Embodiment

References are now made to FIGS. 1-3. The icon indicator is provided for the user to select the reference depth value equal to the depth value of the object 21. The processing module 12 extracts the object 21 with the depth value equal to the selected reference depth value based on the depth map of the full depth map D1. The object 21 is selected to be the target object. The processing module 12 further magnifies the object 21, and regards the full depth map D1 as the background image. The full depth map D1, the frame image W, and the magnified object 21 are overlapped in order. The composite image D2 with a stereoscopic effect shown in FIG. 3 is formed.

### Sixth embodiment

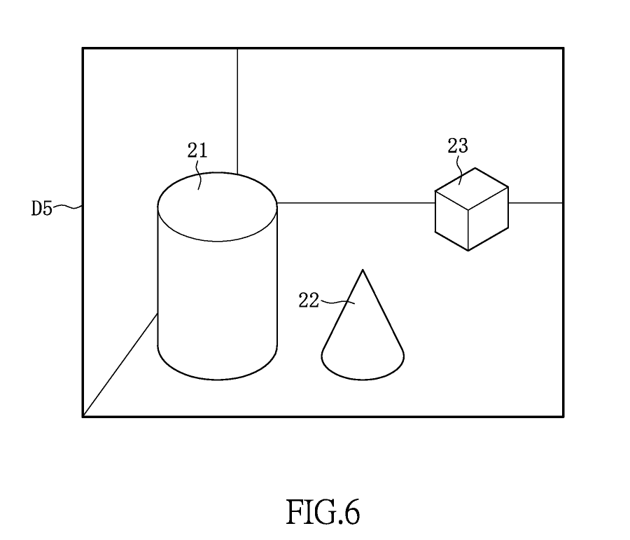

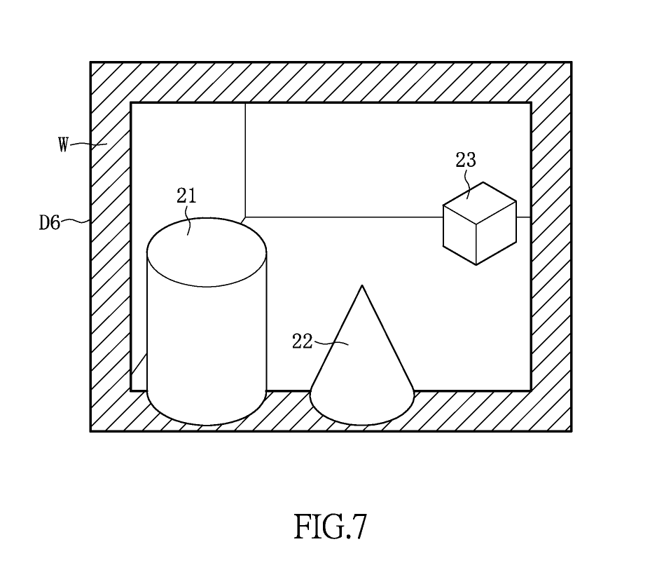

References are made to FIGS. 6 and 7. FIG. 6 schematically shows a full depth map. FIG. 7 shows the schematic diagram of a fourth composite image. The memory module 13 further stores the full depth map D5 and its corresponding depth map. The depth values of the object 21 and the object 22 in the full depth map D5 are the same. The object 23 has the deepest depth of field as compared to those of the object 21 and the object 22. The user selects the reference depth value through the icon indicator when the reference depth value is equal to or larger than the depth values of the object 21 and object 22, and as well smaller than the depth value of the object 23. The processing module 12 then extracts the object 21 and the object 22 from the full depth map D4 based on its corresponding depth map. Both the object 21 and object 22 are the candidates of target object in the current example. The processing module 12 regards the full depth map D5 as the background image. The background image, the frame image W, and the magnified object 21 and object 22 are overlapped to form a composite image D6. The object 21 and the object 22 are standing out from the frame image W in the composite image, as shown in FIG. 7.

According to the embodiments described in FIGS. 4, 5, and 7, the user may select a specific object for the processing module 12 to decide the reference depth value through the display module 11, or select the reference depth value via the icon indicator. If there are two or more objects with depth values smaller than the reference depth value, the processing module 12 retrieves all the objects having the depth values larger than the reference depth value. These objects are overlapped in front of the frame image and the background image. Alternatively, the processing module 12 retrieves at least one object with the highest depth value from all the objects having the depth values smaller than the reference depth value. This object is then overlapped in front of the frame image and the background image. The embodiments in the disclosure are related to all schemes incorporating a frame image to highlight a target object, but not limited to the mentioned methods to form the composite image.

In brief, referring to the embodiments described in FIGS. 2-7, the electronic apparatus 1 is used to extract the at least one target object with the depth value smaller than or equal to the reference depth value, overlap the target object(s) in front of the frame image W, and further make the background image appear behind the frame image W. The final composite image makes the target object to be conspicuous and renders the picture with a stereoscopic effect.

Further, the conspicuous target object may also be magnified in a magnifying power. The magnifying power is usually the value more than one, but also can keep in the original size when the magnifying power is equal to one. The background image may have the magnifying power larger than, equal to, or smaller than one due to the user's configuration. However, the magnifying power applied to those images may not be limited to any specified value, for example, the target object may have the magnifying power smaller than one, and the background image may have the magnifying power equal to one. According to one of the embodiments, the frame image W may completely cover the peripheral region of the background image, and the magnifying power for the background image is smaller than or equal to the magnifying power of the target object, thereby to effectively highlight the selected target image for rendering the stereoscopic effect.

It is worth noting that the frame image W mentioned in each of the FIGS. 3-5 and 7 is a hollow-rectangular image with black frame. The embodiments in the disclosure may not exclude any shape or color of the frame image W, but may be modified due to the practical need. Because the magnifying power for the target object may be larger than, or equal to that for the background image, the magnified target object may completely cover the original target object within the background image.

Furthermore, in one further embodiment, the processing module 12 may continuously magnify the object 21, object 22, or object 23 within a period of time. The processing module 12 also controls the display module to display the magnified image in a continuous period in real time. Therefore, the device is able to show a dynamic display with continuously-changed magnifying power.

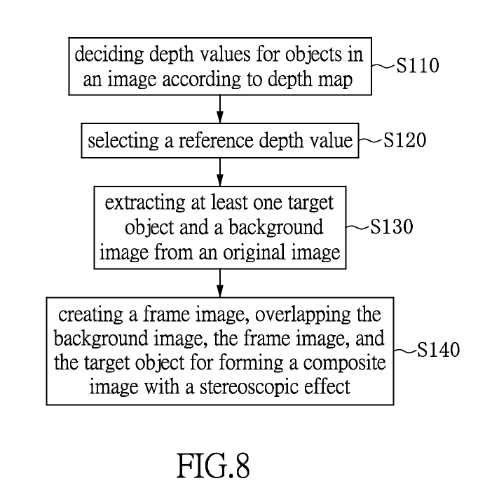

FIG. 8 shows a flow chart illustrating the image processing method in one of the embodiments. The steps in the method may be executed in the electronic apparatus 1 which is described in the foregoing figures. The method for processing the image is described as follows.

According to a depth map, one or more depth values with respect to the one or more objects of an original image are decided in the beginning step S110. In the step, the original image may be the full depth map D1 shown in FIG. 2, or the full depth map D5 shown in FIG. 6. The depth map is configured to correspond to the original image. In the depth map, the distance relationship among the objects 21, 22 and 23 in the original image can be retrieved. Therefore, according to the depth map, the electronic apparatus 1 may determine the depth values with respect to the several extracted objects of the original image. The details to determine the depth value for every object are well-known technology.

Next, in step S120, a reference depth value is selected. In this step, the user may select the object 21, object 22 or object 23 from the image displayed on the electronic apparatus 1 such as the full depth map D1 in FIG. 2 or the full depth map D5 in FIG. 6. Thus, the electronic apparatus 1 determines a reference depth value based on the depth value of the selected object such as the object 21. Alternatively, the user can also select one of the depth values through the mentioned icon indicator, such as using the above-mentioned scroll bar to indicate the range of depth values. The icon indicator allows the electronic apparatus 1 to make this selected depth value as a reference depth.

In step S130, at least one target object and a background image are extracted from the original image. In the step, the electronic apparatus 1 extracts at least one target object from the original image according to the reference depth value. The depth value of the target object is smaller than or equal to the reference depth value. Further, the electronic apparatus 1 may also extract the background image from the original image. It is noted that the background image is configured to be the original image or part of the original image.

In step S140, a frame image is generated and overlapped with the background image, and the target object in an order. A composite image with a visual stereoscopic effect can be created. In the step, the electronic apparatus 1 makes the frame image, such as the frame image W shown in FIG. 3, FIG. 4, FIG. 5, or FIG. 7, overlap the peripheral region of the background image. Next, using the electronic apparatus 1, the target object is overlapped over the frame image so as to cover the portion corresponding to the target object in the background image. The electronic apparatus 1 then combines the overlapped background image, the frame image, and the target object. The final composite image makes the target object to be conspicuous and renders the picture with stereoscopic effect.

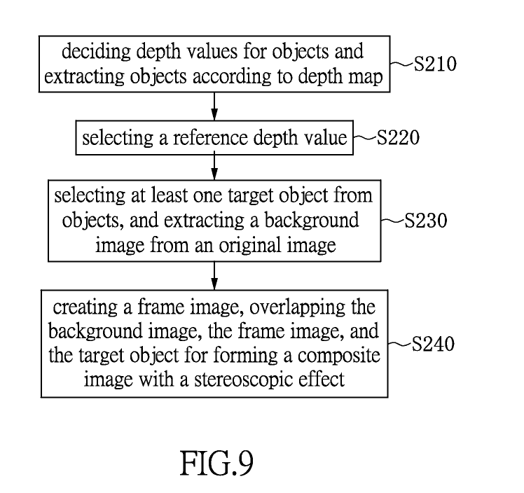

Reference is made to FIG. 9 showing another flow chart illustrating the image processing method in one further embodiment. The image processing method may be executed in the electronic apparatus 1, for example the device shown in FIG. 1. The method, referring to FIGS. 1-7 and 9, is as follows.

In step S210, according to a depth map, depth values with respect to multiple objects in an original image can be determined. Then the multiple objects may be extracted based on the depth map corresponding to the original image. It is noted that the details to extract the objects based on the depth map are well known.

In step S220, based on the manner of the step S120, a reference depth value is selected.

Next, in step S230, at least one target object from the extracted objects is selected. A background image is extracted from the original image. Since the several objects have been extracted from the original image in the step S210, at least one target object can be directly selected from the several objects being extracted by the electronic apparatus 1 in this step according to the reference depth value selected in the step S220. It is noted that the depth value of the target object is smaller than or equal to the reference depth value. Further, the background image can also be extracted from the original image according to the reference depth value.

In step S240, as in the previously-mentioned step S140, a frame image is created and overlaps the background image and the at least one object, in a specific order. The composite image with a visual stereoscopic effect is therefore created by making the target image conspicuous.

It is noted that, in order to further highlight the target object with the stereoscopic effect, the target object may be magnified or make the background image shrunk in advance in between the step S130 and step S 140, or between the step S230 and the step S240. Then the step S140 or step S240 is performed. After that, the background image, the frame image, and the target object are overlapped in an order. Therefore, the target object can be more conspicuous in the picture. However, the magnifying powers for the target object and the background image are not limited to any value, that is, the magnifying power of the background image may be smaller than, equal to, or larger than one and the magnifying power of the target object may be larger than or equal to one. However, the magnifying power of the background image must be smaller than or equal to that of the target object for effectively highlighting the target object through the stereoscopic effect.

Still further, in one further embodiment, one more method for the electronic apparatus 1 to decide the magnifying power for the target object and the background image is also provided. A difference between the depth value of the target object and the reference depth value is firstly measured. The difference is able to render a magnifying power of the target object. The magnifying power for the target object is greater when the difference is larger.

The steps in the method described in the FIG. 8 and FIG. 9 are exemplarily provided, but the order of the steps may not be used to limit the scope of the embodiments of the invention.

In summation, the disclosure provides an image processing method and an electronic apparatus used to implement the method. Based on a depth map, the distance relationship among the multiple objects can be determined. The target object and the background image are selected in an original image. The target object may be magnified and overlaps a frame image. The background image is overlapped behind the frame image in the picture. The target object is therefore standing out of the picture and rendering a visual stereoscopic effect. In other words, the method described above achieves an easy and a low cost solution to create a stereoscopic image as compared to the conventional arts because the electronic apparatus in the method merely requires an original image and a corresponding depth map to render the visual stereoscopic effect in the picture.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

What is claimed is:

1. An image processing method, comprising:
deciding depth values of multiple objects in an original image based on a depth map; wherein the depth map is associated with the original image, the objects include at least one first object and at least one second object, and the depth value of the at least one first object is smaller than that of the at least one second object;
receiving a reference depth value;
retrieving the at least one first object and a background image from the original image;
maintaining a size of the at least one first object, or magnifying the at least one first object; wherein the depth value of the at least one first object is smaller than or equal to the reference depth value, and the depth value of the at least one second object is larger than the reference depth value;
creating a frame image, allowing the at least one first object and the background image to be overlapped in front of the frame image and in the rear of the frame image respectively; and
combining the overlapped the at least one first object, the frame image and the background image for generating a composite image.

2. The method according to claim 1, further comprising:
maintaining the background image with its original size, or magnifying the background image, wherein a magnifying power of the background image is smaller than or equal to that of the at least one first object.

3. The method according to claim 1, further comprising:
computing a difference between the reference depth value and the depth value of the at least one first object so as to determine a magnifying power of the at least one first object; wherein if the difference is bigger, the magnifying power of the at least one first object is larger.

4. The method according to claim 1, wherein the background image includes the at least one first object and the at least one second object.

5. The method according to claim 1, wherein the frame image overlaps a peripheral region of the background image.

6. An electronic apparatus, comprising:
a processing module used to execute an image processing method recited in claim 1, allowing the at least one first object to be conspicuous in a composite image by making the first object appear in front of the frame image; and
a display module, coupled to the processing module, used to display an original image and/or the composite image.

7. The apparatus according to claim 6, wherein the display module displays an icon indicator provided for a user to select a reference depth value.

8. The apparatus according to claim 6, further comprising:
a memory module, coupled to the processing module, used to store the original image and a depth map.

9. The apparatus according to claim 6, further comprising:
a camera module, coupled to the processing module, used to capture images from a scene;
wherein the camera module uses the processing module to perform image processing for creating the depth map and the original image.

10. The apparatus according to claim 6, wherein the display module allows a user to select the at least one first object, and the processing module is used to decide the reference depth value according to the depth value of the at least one first object.
